(19) United States
(12) Patent Application Publication
(10) Pub. No.: US 2014/0071014 A1
(43) Pub. Date: Mar. 13, 2014

(54) MULTI-BAND ANTENNA

(71) Applicant: HON HAI PRECISION INDUSTRY CO., LTD., New Taipei (TW)

(72) Inventor: LUNG-SHENG TAI, New Taipei (TW)

(73) Assignee: HON HAI PRECISION INDUSTRY CO., LTD., New Taipei (TW)

(21) Appl. No.: 14/023,417

(22) Filed: Sep. 10, 2013

(30) Foreign Application Priority Data
Sep. 10, 2012 (TW) 101132903

(51) Int. Cl. H01Q 5/00; H01Q 5/01

(52) U.S. Cl. CPC H01Q 5/0027; H01Q 5/01
USPC 343/848; 343/700 MS

(57) ABSTRACT

A multi-band antenna includes a longitudinal grounding element, a longitudinal arm extending along a longitudinal direction thereof, and a first lateral arm extending from the longitudinal arm and separating from the grounding plate. The longitudinal arm connects with the grounding plate through a connecting arm at an end thereof The first lateral arm is disposed adjacent to the opposite end of the longitudinal arm to divide the longitudinal arm to two radiating portions. The first lateral arm defines a feeding point. This structure of the antenna benefits to radiating efficiency and isolation of adjacent antennas.

### BACKGROUND OF THE INVENTION

1. Field of the Invention

The present disclosure relates to a multi-band antenna, and more particularly to a multi-band antenna performing well in radiating efficiency and isolation of adjacent antenna.

2. Description of Related Art

With the miniaturization trend of portable electronic devices, the space between an antenna and other components inner the electronic devices and the space between two antennas become smaller and smaller. Planar Inverted-F Antenna (PIFA) is a type of often-used antenna inner the electronic devices. However, as the space between the PIFA and other components is very small, other components have negative impacts on the antenna which results in reducing the radiating efficiency of the antenna. And as the space between two PIFAs is very small, the isolation of the two PIFAs becomes bad.

In view of the above, an improved antenna is desired to overcome the problems mentioned above.

### SUMMARY OF THE INVENTION

Accordingly, an object of the present disclosure is to provide an antenna performing well in radiating efficiency and isolation of adjacent antenna.

According to one aspect of the present disclosure, a multi-band antenna is provided. The multi-band antenna comprises a grounding element extending in a longitudinal direction and defining a longitudinal edge; a longitudinal arm extending in the longitudinal direction and defining a slot with the grounding element, the longitudinal arm comprising a first end and a second end opposite to each other, and the second end connecting the longitudinal edge through a connecting arm; and a first lateral arm extending from the longitudinal arm towards the grounding element and defining a feed point; wherein the first lateral arm adjacent to the first end of the longitudinal arm dividing the longitudinal arm into a shorter first radiating section and a longer second radiating section.

Other objects, advantages and novel features of the disclosure will become more apparent from the following detailed description when taken in conjunction with the accompanying drawings, in which:

### BRIEF DESCRIPTION OF THE DRAWINGS

FIG. 1 is a perspective view of an antenna in accordance with a preferred embodiment of the present disclosure;

FIG. 2 is a front view of the antenna shown in FIG. 1;

FIG. 3 is a left side view of the antenna shown in FIG. 1.

### DETAILED DESCRIPTION OF THE INVENTION

Reference will now be made to the drawings to describe a preferred embodiment of the present disclosure in detail.

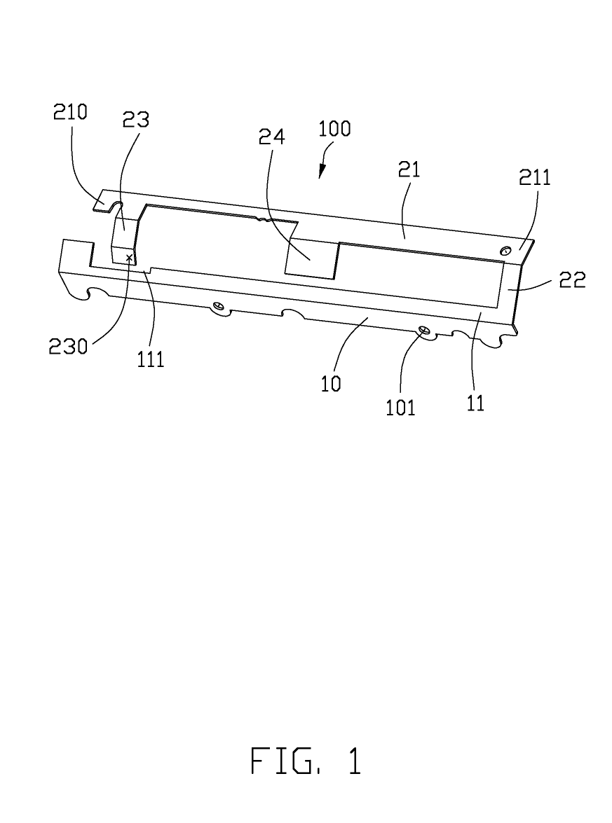

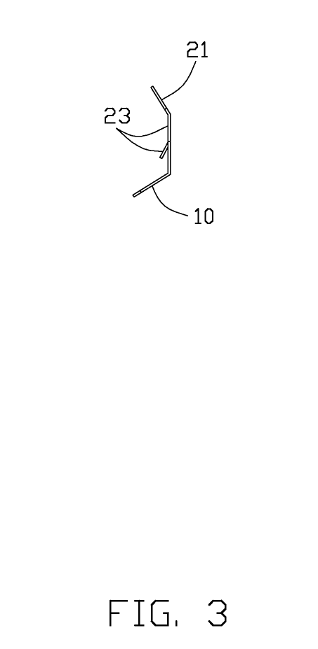

Referring to FIG. 1 to FIG. 3, an antenna 100 in accordance with the preferred embodiment of the present disclosure, is stamped from a metal sheet. The antenna 100 comprises a grounding element 10 extending in a longitudinal direction and defining a longitudinal edge, and a radiating element extending from the longitudinal edge. The grounding element 10 comprises a plurality of holes 101 for fixing the antenna 100.

The radiating element comprises a longitudinal arm 21 extending in the longitudinal direction and defining a slot with the grounding element 10. The longitudinal arm 21 comprises a first end 210 and a second end 211 opposite to each other in the longitudinal direction. A connecting arm 22 connects the second end 211 and the longitudinal edge of the grounding element 10. The grounding element 10 is longer than the longitudinal arm 21 in the longitudinal direction.

A first lateral arm 23 extends from the longitudinal arm 21 towards the grounding element 10. The first lateral arm 23 is adjacent to the first end 210 dividing the longitudinal arm 21 into a shorter first radiating section 31 and a longer second radiating section 32. A feed point 230 is defined on the end of the first lateral arm 23 for electrically connecting a coaxial cable thereon.

A second lateral arm 24 extends from the longitudinal arm 21 and locates between the first lateral arm 23 and the connecting arm 22 for adjusting the impedance matching of the first and second radiating sections 31, 32. The second lateral arm 24 is wider than the first lateral arm 23 in the longitudinal direction. The second radiating section 32 comprises a narrow section 213 between the first lateral arm 23 and the second lateral arm 24 and a wide section 214 between the second lateral arm 24 and the connecting arm 22. In the traverse direction perpendicular to the longitudinal direction, the dimension of the narrow section 213 is less than the dimension of the wide section 214. In this embodiment, the dimension of the wide section 214 is at least twice the dimension of the narrow section 213.

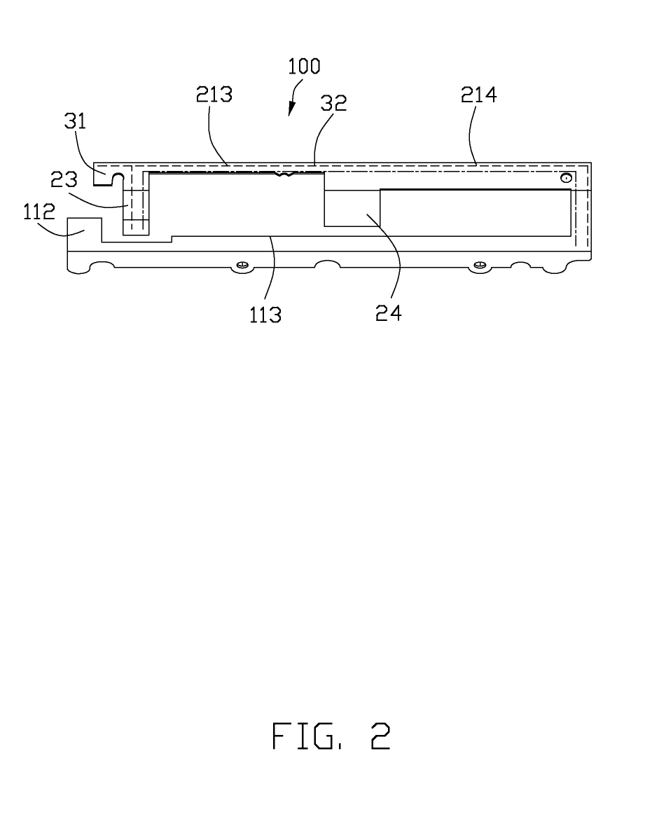

In the preferred embodiment in accordance with the present disclosure, the grounding element 10 further comprises a secondary plate 11. The connecting arm 22 connects the secondary plate 11 and locates in the same plane with the secondary plate 11. The secondary plate 11 comprises a recess 111 corresponding to the first lateral arm 23 and a free end 112 corresponding to the first end 210 of the longitudinal arm 21, wherein the free end 112 extends towards the longitudinal arm 21 and beyond the end of the first lateral arm 23 in the traverse direction. The first lateral arm 23 is bent twice towards the grounding element 10 defining two creases while the second lateral arm 24 is bent once defining one crease, shown in FIGS. 1, 2. One of the first lateral arm creases is aligned with the second lateral arm crease while the other first lateral arm crease is aligned with the end of the second lateral arm 24 and the free end 112 of the secondary plate 11. The end of the first lateral arm 23 is aligned with an upper end 113 of the secondary plate 11.

The embodiment of the present disclosure comprises the first lateral arm 23 dividing the longitudinal arm 21 into the first and second radiating sections 31, 32. The feed point 230 is defined on the end of the first lateral arm 23. From the feed point 230 to the joint of the connecting arm 22 and the secondary plate 11, i.e. the first lateral arm 23, the second radiating section 32 and the connecting arm 22, serves as a loop antenna working on a lower frequency band, as the dotted line shown in FIG. 2. From the feed point 230 to the first end 210 of the longitudinal arm 21, i.e. the first lateral arm 23 and the first radiating section 31, serves as a planer inverted-F antenna working on a higher frequency band. The second lateral arm 24 is located between the feed point 230 and the grounding element 10 for adjusting the impedance matching of the lower and higher frequency band. The preferred embodiment of the present disclosure is a hybrid antenna of loop and planer inverted-F antenna. This structure of the antenna is of great benefit to radiating efficiency and isolation.

While preferred embodiment in accordance with the present disclosure has been shown and described, equivalent modifications and changes known to persons skilled in the art according to the spirit of the present disclosure are considered within the scope of the present disclosure as defined in the appended claims.

What is claimed is:

1. A multi-band antenna comprising:
a grounding element extending in a longitudinal direction and defining a longitudinal edge;
a longitudinal arm extending in the longitudinal direction and defining a slot with the grounding element, the longitudinal arm comprising a first end and a second end opposite to each other, and the second end connecting the longitudinal edge through a connecting arm; and
a first lateral arm extending from the longitudinal arm towards the grounding element and defining a feed point, the first lateral arm adjacent to the first end of the longitudinal arm dividing the longitudinal arm into a shorter first radiating section and a longer second radiating section.

2. The multi-band antenna as claimed in claim 1, wherein the antenna further comprises a second lateral arm extending from the longitudinal arm towards the grounding element, and wherein the second lateral arm locates between the first lateral arm and the connecting arm for adjusting the impedance matching of the first and second radiating section.

3. The multi-band antenna as claimed in claim 2, wherein the second lateral arm is wider than the first lateral arm in the longitudinal direction.

4. The multi-band antenna as claimed in claim 3, wherein the second radiating section comprises a narrow section between the first lateral arm and the second lateral arm, and a wide section between the second lateral arm and the connecting arm, and wherein the dimension of the narrow section is less than the dimension of the wide section in a traverse direction perpendicular to the longitudinal direction.

5. The multi-band antenna as claimed in claim 4, wherein the grounding element further comprises a secondary plate, the connecting arm connects the secondary plate and in the same plane with the secondary plate.

6. The multi-band antenna as claimed in claim 5, wherein the secondary plate comprises a recess corresponding to the first lateral arm.

7. The multi-band antenna as claimed in claim 5, wherein the secondary plate comprises a free end corresponding to the first end of the longitudinal arm, and wherein the free end extends towards the longitudinal arm and beyond the end of the first lateral arm in the traverse direction.

8. The multi-band antenna as claimed in claim 6, wherein the end of the first lateral arm is bent towards the grounding element.

9. The multi-band antenna as claimed in claim 2, wherein the first lateral arm is bent twice defining two creases while the second lateral arm is bent once defining one crease, and wherein one of the first lateral arm creases is aligned with the second lateral arm crease, the other first lateral arm crease is aligned with the end of the second lateral arm.

10. A multi-band antenna comprising:
a grounding element extending in a longitudinal direction and defining a longitudinal edge;
a radiating element extending from the longitudinal edge, the radiating element comprising:
a longitudinal arm defining a first end and a second end opposite to each other in the longitudinal direction;
a connecting arm connecting the second end and the grounding element; and
a first lateral arm between the first and second ends, extending from the longitudinal arm towards the grounding element and defining a gap with the grounding element, a feed point defined on the first lateral arm.

11. The multi-band antenna as claimed in claim 10, wherein any two of the longitudinal arm, the connecting arm and the grounding element are not in the same plane.

12. The multi-band antenna as claimed in claim 10, wherein the antenna further comprises a second lateral arm extending from the longitudinal arm towards the grounding element, and wherein the second lateral arm locates between the first lateral arm and the connecting arm.

13. The multi-band antenna as claimed in claim 12, wherein the first lateral arm is longer than the second lateral arm in the direction that the first and second lateral arms extending towards.

14. The multi-band antenna as claimed in claim 10, wherein the grounding element further comprises a secondary plate, and wherein the secondary plate defines a recess corresponding to the first lateral arm to form said gap.

15. The multi-band antenna as claimed in claim 10, wherein the grounding element is longer than the longitudinal arm in the longitudinal direction.

16. A multi-band antenna comprising:
a grounding element extending along a longitudinal direction in a first plane;
a longitudinal arm extending along said longitudinal direction in a second plane, which is angled with the first plane, and essentially spaced from said grounding element in a parallel relation;
a connection arm linked between said grounding element and said longitudinal arm around respective one ends thereof, and located in a third plane angled with both said first plane and said third plane; and
a first lateral arm extending around the other end of the longitudinal arm toward the grounding element; wherein
said first lateral arm extends in the second plane with, at a free end, a feed point portion extending in a fourth plane angled to all said first plane, said second plane and said third plane.

17. The multi-band antenna as claimed in claim 16, wherein the grounding element defines a recess confronting said feed point portion.

18. The multi-band antenna as claimed in claim 16, further including a second lateral arm extending from the longitudinal arm toward the grounding element and located between the first lateral arm and the connection arm, wherein said second lateral arm lies in the third plane.

19. The multi-band antenna as claimed in claim 18, wherein said longitudinal arm defines a recession between said first lateral arm and said second lateral arm.

20. The multi-band antenna as claimed in claim 16, wherein the grounding element further includes another portion extending in a fifth plane where a securing area is located to fix said antenna in position.
